(19) United States
(12) Patent Application Publication
(10) Pub. No.: US 2003/0152659 A1
(43) Pub. Date: Aug. 14, 2003

(54) Children's toy for making confections

(76) Inventors: Kristin A. McCloskey, Carlsbad, CA (US); David J. Fitzgerald, Hayward, CA (US); Kwok F. Tang, Oakland, CA (US)

Correspondence Address: KOLISCH HARTWELL, P.C., 520 S.W. YAMHILL STREET, SUITE 200, PORTLAND, OR, 97204, US

(21) Appl. No.: 10/071,882

(22) Filed: Feb. 8, 2002

(51) Int. Cl. A23G 1/22

(52) U.S. Cl. 425/256; 249/126

(57) ABSTRACT

A children's toy for making confections of preselected designs. The toy includes a base platform, and confection mold trays adapted to be stacked on the base platform. The base platform includes a vertical alignment structure for aligning the confection mold trays, as they are stacked on the base platform. The confection mold trays include at least one mold cavity for forming confections from a confection solution.

### FIELD OF THE INVENTION

The present invention relates generally to children's toys for making confections. More specifically, the invention relates to a children's toy having a set of molds for making confections of preselected designs.

### BACKGROUND OF THE INVENTION

Children's toys for baking and/or making eatable goods are well known in the art. For example, the EASY BAKE® Oven has been used by children to bake cakes for years. The EASY BAKE® Oven requires complicated mixing of ingredients and requires use of a heated oven that may cause bums or other injuries to young children.

Chewy candies or confections are very popular among young children. Young children enjoy hands-on creative activities such as coloring and finger painting. It would be desirable to provide young children with a hands-on creative toy to assist in making chewy confections of various designs and flavors. Such a toy should be enjoyable to use, provide play value and instruct children on making eatable goods. The toy should be safe to use and not require use of complicated mixing instructions or operation.

### SUMMARY OF THE INVENTION

The present invention includes a children's toy for making confections of preselected designs incorporating a base platform and a confection mold tray adapted to be stacked on the base platform. The base platform includes a vertical alignment structure for aligning the confection mold trays, as they are stacked on the base platform. The confection mold trays include at least one mold cavity for forming confections from a confection solution.

### BRIEF DESCRIPTION OF THE DRAWINGS

FIG. 1 is a perspective assembly view of a children's toy for making confections constructed according to the present invention.

FIG. 2 is a partially cut-away perspective view of the children's toy of FIG. 1, shown in an assembled configuration.

FIG. 3 is a cross-sectional view of the children's toy of FIG. 2, showing the stacked configuration of a set of confection mold trays.

FIG. 4 is a perspective view of a confection coating powder being poured into a tray lid.

FIG. 5 is a perspective view of a confection mix being added to a confection solution dispenser.

FIG. 6 is a perspective view of a user dispensing a confection solution from the dispenser of FIG. 5 into a mold tray.

FIG. 7 is a perspective view of a user removing a confection from a mold tray using a pair of tweezers.

FIG. 8 is a perspective view of a user dipping a confection into confection coating powder in the tray lid of FIG. 4.

### DETAILED DESCRIPTION AND BEST MODE OF THE INVENTION

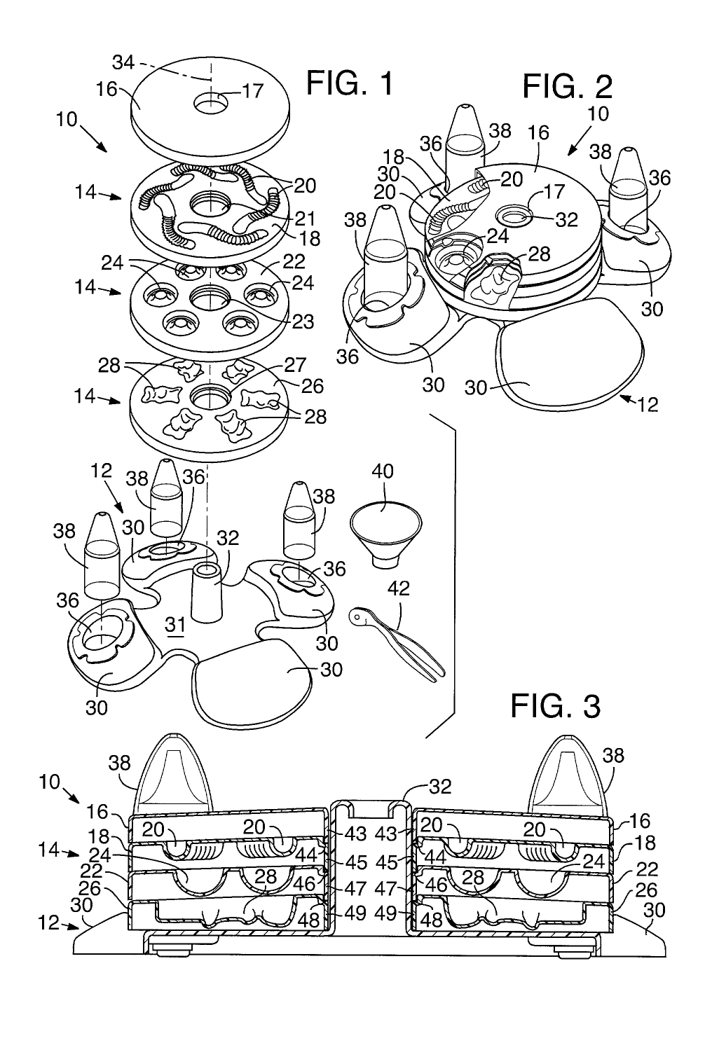

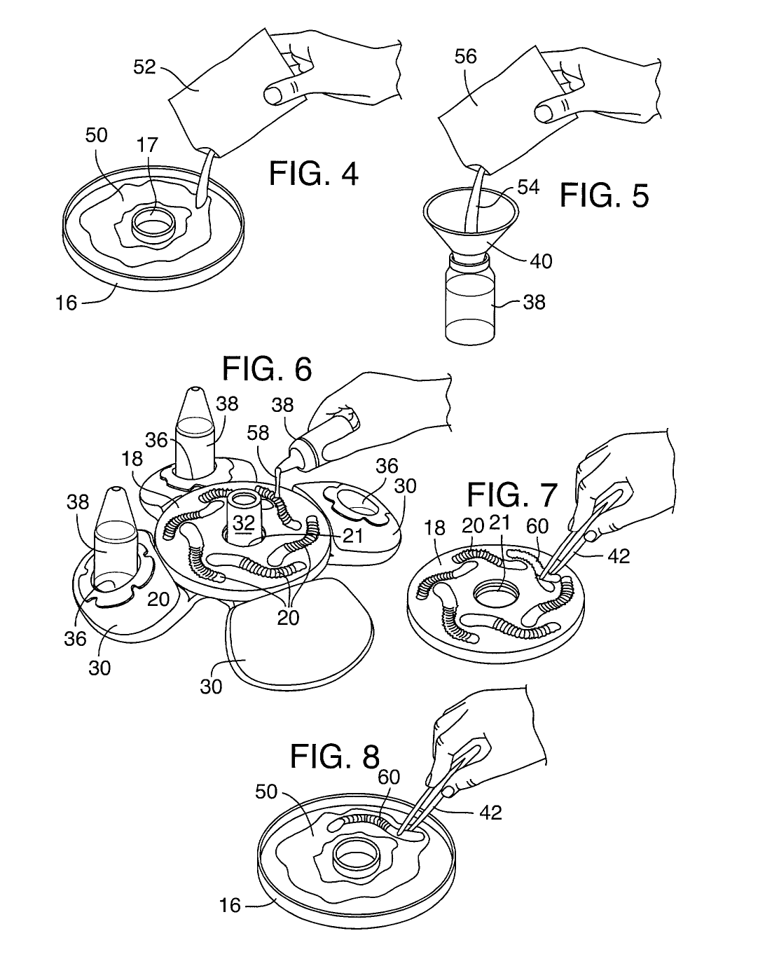

A children's toy for making confections constructed according to the present invention is shown in FIG. 1, and indicated generally at 10. Children's toy 10 includes a base platform 12, a plurality of confection mold trays 14, and a tray lid 16. The play value of toy 10 may be enhanced by sizing the toy for ease of use by a young child. Base platform 12 is configured to support confection mold trays 14, and tray lid 16 is detachable for covering confection mold trays 14, and keeping them clean and free of dust, dirt and other debris. Base platform 12, confection mold trays 14, and tray lid 16 may be formed from molded plastic, and may be integrally formed or formed from a plurality of parts that are secured together by screws, clips or other suitable fasteners. Alternatively, base platform 12, confection mold trays 14, and tray lid 16 may be made of some other suitable material. Base platform 12 is configured to accommodate a plurality of confection mold trays 14 in a stacked configuration.

A set of multiple confection mold trays 14 are shown in FIG. 1, and include a first confection mold tray 18, a second confection tray 22, and a third confection tray 26. Confection mold trays 18, 22, and 26 may be disc shaped, as shown in FIG. 1. Alternatively, confection mold trays 14 may be other shapes, including geometric shapes such as polygons, or amorphous shapes, etc. Confection mold trays 14 may include an alignment structure configured to align the trays when they are stacked on base platform 12. It should be understood, that while FIGS. 1-3 show three confection mold trays, a greater or smaller number of trays are contemplated by the present invention.

First confection mold tray 18 includes a first mold design 20 of preselected design. As shown in FIGS. 1-3, first mold design cavity 20 resembles an earthworm. It should be understood that any shape may be used for first mold design cavity 20; the primary goal of the shape of first mold design cavity 20 is to enhance the play value of toy 10. Mold tray 18 may further include—as alignment structure—an alignment aperture 21 configured to align mold tray 18 when the tray is stacked on base platform 12, as will be explained in more detail below.

Second confection mold tray 22 may include an alignment aperture 23 as the alignment structure, aperture 23 passing through mold tray 22 for aligning the mold tray when it is stacked on base platform 12. Second confection mold tray 22 may include a second mold design cavity 24. As shown in FIGS. 1-3, second mold design cavity 24 has a ring shape, and resembles the shape of a “doughnut.” It should be understood that any shape may be used for second mold design cavity 24; the primary goal of the shape of second mold design cavity 24 is to enhance the play value of toy 10.

As noted above, the set of confection mold trays 14 may include a third confection mold tray 26. Third mold tray 26 may include an alignment aperture 27 extending through a portion thereof. Third mold tray 26 includes a third mold design cavity 28. As shown in FIGS. 1-3, third mold design cavity 28 has been shaped to resemble a bear. It should be understood that any shape, including other animal shapes, may be used for third mold design cavity 28, the primary goal of the shape of third mold design 28 is to enhance the play value of toy 10.

Confection mold trays 18, 22, and 26 are shown having different designs for mold design cavities 20, 24, and 28 in FIGS. 1-3. However, toy 10 may include confection mold trays 14 containing similar mold cavities. Alternatively, toy 10 may include mold trays 14 having different mold design cavities on a single confection mold tray. For example, confection mold tray 18 may include all three different mold design cavities 20, 24, and 28.

As shown in FIG. 1, tray lid 16 includes a central aperture 17 passing through a portion thereof for alignment of the tray lid with base platform 12. Aperture 17 is configured to align with apertures 21, 23, and 27 of mold trays 18, 22, and 26, such that tray lid 16 may be aligned with each of the set of mold trays 14 for stacking on base platform 12. As shown, apertures 17, 21, 23, and 27 are positioned coaxially around a common control axis 34.

Base platform 12 includes pods or support arms 30 positioned around the periphery of a central portion 31 of base platform 12. Extending vertically from central portion 31 is vertical support member 32. As shown, vertical support member 32 is concentric with a central axis 34. Vertical support member 32 and apertures 17, 21, 23, and 27 are configured to work together in aligning confection mold trays 14 and tray lid 16 with base platform 12. Specifically, vertical support member 32 is sized to fit within apertures 17, 21, 23, and 27. Additionally, vertical support member 32 and apertures 17, 21, 23, and 27 are concentric with central axis 34, when each of confection mold trays 14 is properly aligned for stacking on base platform 12. For example, mold tray 18 may be placed on base 12 by aligning aperture 21 with vertical support member 32 and lowering the confection mold tray onto base platform 30.

As noted above, base platform 12 includes pods or support arms 30, which may include receptacles 36. Receptacles 36 may be configured to receive confection dispensers 38. Receptacles 36 provide a convenient location for storing dispensers 38 while using toy 10 to make confections.

As shown, confection dispensers 38 include bottles. It should be understood that receptacles 36 and confection dispensers 38 may vary in shape and size in accordance with toy 10 of the present invention. For example, confection dispensers 38 may be shaped to resemble a tube of paste and receptacles 36 may be correspondingly shaped to receive the tubes.

Toy 10 includes a funnel 40 and a pair of tweezers 42, as shown in FIG. 1. Funnel 40 may be used to fill dispensers 38 with a confection mixture, which when mixed with warm water forms a confection solution that solidifies into a gel confection. The confection solution may be subsequently poured out of dispensers 38 into mold design cavities 20, 24, and/or 28. Tweezers 42 may be used to remove solidified gel confections from the mold design cavities.

As shown in FIG. 2, toy 10 is shown including mold trays 14 and tray lid 16 stacked on base platform 12. FIG. 2 includes three cut away areas to show the order of the stacked mold trays. It should be understood that mold trays 18, 22, and 26 may be stacked in any order on base 12. Additionally, each mold tray 18, 22, and 26 may be used individually on base 12 or in combination with any number of additional confection mold trays.

When confection mold trays 14 are in the stacked configuration, they may be easily rotated by a child relative to base 12 to position each tray for filling with confection solution. Each confection mold tray 14 may also be rotated relative to other confection mold trays in the stack. Toy 10 may be designed to allow relative rotation between stacked confection mold trays to enhance the play value of the toy.

While the illustrated embodiment of the present invention shows a set of three confection mold trays, it should be understood that any number of confection mold trays may be used according to the present invention. Additionally, a child may use less than all of the confection mold trays included with toy 10.

FIG. 3 illustrates the interaction between adjacent mold trays 14. Tray lid 16 is shown in the top position of the stack of mold trays 14. Aperture 17 through tray lid 16 includes a collar portion 43. Mold tray 18 is shown positioned below tray lid 16 in the stack. Aperture 21 of mold tray 18 includes a counter sink portion 44 adapted to receive the collar portion 43 of mold tray lid 16. In this manner, tray lid 16 nests within aperture 21 of mold tray 18. Similarly, mold tray 18 includes a mold tray collar portion 45, which extends downward into a counter sink portion 46 in the top of aperture 23 of confection mold tray 22. In this manner confection mold tray 18 nests within aperture 23 of mold tray 22. Likewise, mold tray 22 includes a collar portion 47, which extends downward into a counter sink portion 48 of mold tray 26. Please note that mold tray 26 includes a collar portion 49, which may extend down into any of the other counter sink portions 44, 46. However, as shown in FIG. 3, confection mold tray 26 is at the bottom of the stack of confection mold trays, and therefore the collar portion 49 extends down to rest on base platform 12.

From the above description of FIG. 3, it should be apparent that each of mold trays 14—specifically mold trays 18, 22, and 26—may be stacked in any order and are configured to nest with adjacent mold trays. Collar portions 45, 47, and 49 extend downward into an adjacent counter sink portion 44, 46, and 48.

A user makes confections with toy 10 by first removing tray lid 16 from the top of the stack of confection mold trays 14. Tray lid 16 may be inverted and filled with a powdered coating substance 50, from a powdered coating substance package 52. Confections may be dipped into powder coating substance 50, enhancing the play value of toy 10.

Next, one of dispensers 38 may be removed from base 12 for filling with a confection solution. A confection solution is a flowable substance that will solidify into a candy confection. The first step in creating a confection solution is to fill dispenser 38 with warm water. A demarcation line (not shown) may be marked on dispenser 38 to indicate the proper quantity of warm water to be used. Funnel 40 may be inserted into dispenser 38 to aid in filling the dispenser with a confection mixture 54. Confection mixture 54 is then poured out of a confection-mixture package 56 into funnel 40, as shown in FIG. 5. The warm water and confection mixture 54 may be placed in dispenser 38 in any order. After dispenser 38 has been filled with both warm water and confection mixture 54, the contents of dispenser 38—the warm water and confection mixture-may be mixed together either by shaking or stirring the contents to form a confection solution.

It should be noted, that the steps for making a confection solution 58 may be repeated using different flavored confection mixtures. A user may want to fill the other dispensers 38 of toy 10 with other flavors of confection solution. Using different flavored confection mixtures to make several different flavors of confection solutions enhances the play value of toy 10. Using multiple dispensers 38, each with a different flavor, enables children to create different flavored confections at the same time. Additionally, a single confection having a mixture of flavors may be made.

Following the making of the confection solution, a confection mold tray 14 is selected from the set of confection mold trays, and placed on base platform 12. For example, confection mold tray 18 has been selected and placed on base platform 12 by aligning aperture 21 with vertical support member 32 and vertically lowering mold tray 18 onto the base platform, as shown in FIG. 6. Once a confection mold tray has been selected, a confection solution 58 may be poured from dispenser 38 into the confection mold tray design cavities. For example, as shown in FIG. 6, a user, such as a child, is pouring confection solution 58, out of dispenser 38, into mold design cavity 20 of mold tray 18. Mold tray 18 is rotatable around vertical support member 32 and central axis 34. A child may rotate mold tray 18 to make filling mold cavities 20 easier and enhancing the play value of toy 10. This step may be repeated with the other confection mold trays, namely confection mold tray 22 and 26.

After the desired confection mold tray cavities on all the desired confection mold trays have been filled with confection solution, the confection solution needs to harden. Confection solutions will harden at room temperature. However, for faster hardening of the confection solution it may be desirable to place the confection mold trays in a low temperature environment, such as a refrigerator.

Once the confection solution has hardened, or gelled into a confection 60, the confection may be removed from the confection mold tray. For example, confection 60 is shown being removed from confection mold tray 18 with tweezers 42 in FIG. 7. This step may be repeated until all the confections have been removed from confection mold trays 14. Please note, that the rotatable nature of the stacked confection mold trays 10 on base 12 makes removal of confections from the trays easier.

After removal of confection 60 from mold tray 18, the confection may be dipped into powder coating substance 50. Powder coating substance 50 may be granulated sugar, or it may be a sour, or tart substance to enhance the child's eating experience. Alternatively, a child may eat confection 60 without first dipping the confection into powder coating substance 50.

It is believed that the disclosure set forth above encompasses multiple distinct inventions with independent utility. While each of these inventions has been disclosed in its preferred form, the specific embodiments thereof, as disclosed and illustrated herein, are not to be considered in a limiting sense as numerous variations are possible. The subject matter of the inventions include all novel and non-obvious combinations and sub-combinations of the various elements, features, functions and/or properties disclosed herein. Where claims recite “a” or “a first” element or equivalent thereof, such claims should be understood to include incorporation of one or more such elements, neither requiring, nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of those claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A children's toy for making confections of preselected designs, comprising:
a base platform having an alignment member; and
a confection mold tray including an alignment structure configured to engage the alignment member of the base platform.

2. The children's toy of claim 1, including a plurality of confection mold trays.

3. The children's toy of claim 2, wherein the confection mold trays are configured for vertical stacking one on top of another.

4. The children's toy of claim 3, wherein the confection mold trays are rotatable about a center axis.

5. The children's toy of claim 2, wherein the confection mold trays are configured to be interchangeably stacked.

6. The children's toy of claim 2, wherein the confection mold trays are vertically removable from the base platform.

7. The children's toy of claim 2, wherein the confection mold trays include a mold design cavity.

8. The children's toy of claim 7, wherein the confection mold design cavity includes an animal shape.

9. The children's toy of claim 8, wherein the animal shape is an earthworm

10. The children's toy of claim 8, wherein the animal shape is a bear.

11. The children's toy of claim 7, wherein the mold design cavity include a ring shape.

12. The children's toy of claim 1, wherein the base platform includes a mount configured to hold a dispenser for pouring a confection solution into the confection mold tray.

13. The children's toy of claim 12, wherein the dispenser includes a bottle.

14. The children's toy of claim 12, wherein the confection solution is configured to harden to a gel confection.

15. A kit for making confections of preselected designs, comprising:
a base platform having an alignment member;
a plurality of stackable confection mold trays including alignment structure configured to engage the alignment member of the base platform;
a confection mixture configured to be dissolved in a solvent and then solidify into eatable confections; and
instructions for making confections using the base platform, stackable confections molds, and the confections mixture.

16. The kit of claim 15, wherein the instructions include the steps of:
making a confection solution from warm water and the confection mixture;
filling the confection mold trays with the confection solution; and
cooling the confection mold trays to solidify the confection solution into eatable confections.

17. The kit of claim 15, including a plurality of confection mixtures configured to be dissolved in a solvent and then solidify into eatable confections.

18. The kit of claim 15, wherein the base platform includes a mount configured to hold a dispenser for pouring a confection solution into the confection mold trays.

19. A children's toy for making confections of preselected designs, comprising:
a base platform having a vertical alignment member located concentric with a central axis;
a plurality of stackable rotatable confection mold trays including alignment apertures configured to engage the vertical alignment member of the base platform as the trays are stacked, and wherein the trays are configured to rotate around the central axis; and
a confection mixture configured to dissolve in warm water and solidify into eatable confections as the dissolved mixture cools.
